(19) United States
(12) Patent Application Publication
(10) Pub. No.: US 2012/0100032 A1
(43) Pub. Date: Apr. 26, 2012

(54) MOULD ASSEMBLY FOR A HOT ISOSTATIC PRESSING PROCESS

(75) Inventors: Wayne E. VOICE, Nottingham (GB); Junfa MEI, Melbourne (AU); Thomas P. JARVIS, Derby (GB)

(73) Assignee: ROLLS-ROYCE PLC, London (GB)

(21) Appl. No.: 13/253,533

(22) Filed: Oct. 5, 2011

(30) Foreign Application Priority Data
Oct. 20, 2010 (GB) 1017694.9

(51) Int. Cl. B22F 3/15; C04B 35/594

(52) U.S. Cl. 419/49; 425/405.1; 264/604; 425/78

(57) ABSTRACT

The invention relates to a mould assembly for a hot isostatic pressing, HIP, process, comprising: an insert comprising a plurality of pieces which combine to provide a recess in which a protrusion of the component can be formed; and, a holding piece having at least one cavity in which the insert is mateably received.

This invention relates to a mould assembly for manufacturing components using Hot Isostatic Pressing, HIP. In particular, this invention relates to a reusable mould for manufacturing components using HIP.

HIP fabrication involves the consolidation of a metal or ceramic powder under high temperature and high pressure conditions. Typically, net-shape HIP processes use a machined consumable mild steel canister as a mould in which a powder in-fill is consolidated into a required component shape. After the HIP process is complete, the consumable canister is removed from the formed component by machining and pickling.

The use of consumable canisters is inherently time consuming and materially expensive as each manufactured component requires a new canister. Further, the pickling process requires highly caustic chemicals which have cost and potential safety implications for the technology.

The applicants have investigated the use of re-usable moulds in which a substantially incompressible mould is housed within a plain canister. The canister in this instance is still consumable, however, because the features are formed within a re-usable mould, the canister is simpler to design and manufacture.

The use of a reusable mould addresses many of the drawbacks of consumable canisters of the prior art. However, using reusable moulds provides new difficulties.

The present invention seeks to overcome some of the problems the applicant has discovered with re-usable moulds for HIP processes.

In a first aspect the present invention provides a mould assembly for a hot isostatic pressing, HIP, process, comprising: an insert comprising a plurality of pieces which combine to provide a recess in which a protrusion of the component can be formed and a holding piece having at least one formation in which the insert is mateably received.

During a HIP process the mould and constituent powder in-fill expand and contract during the thermal cycle. If the thermal expansion of the mould is greater than that of the component material, any protrusions will be compressed and frictionally retained within the mould when cooled. Subsequent separation often leads to damage of the mould or component. This problem is greater for the manufacture of large components, due to the greater differential in contraction, and for components which include multiple protrusions.

Having a holding piece with an insert which can be split into multiple pieces allows the mould to be disassembled after the HIP process is complete. Hence, each piece of the mould can be pulled obliquely away from the surface of a manufactured component rather than being tangentially slid off a protrusion against any frictional retention.

The component may be for a gas turbine engine. The gas turbine engine may be an aero engine. The component may be one from a group consisting of fan and compressor casings.

The recess formed by the insert pieces correspond to a protrusion to be formed on the first surface of the component. The component protrusion may be one of the group which comprises ribs, flanges and bosses. The recess may be round in cross section. For example, the recess may be circular or oval. The at least one recess may be polygonal in cross section. The at least one recess may be regular or irregular in cross section. The recess may be elongate. The longitudinal axis of the recess may be perpendicular to the general plane of the first part.

The mould assembly may include a canister in which the holding piece and inserts are housed during the HIP process. The canister may have a lid so as to seal it. The lid may be attached to the canister via any suitable means, such as welding. The canister may be a mild steel canister. The canister may have a wall thickness of less than 6 mm. Alternatively, the canister may have a wall thickness less than 5 mm. The canister may have a wall thickness of less than 4 mm. The canister may have a wall thickness greater than 1 mm. The canister may have a wall thickness greater than 2 mm. The canister may have a wall thickness greater than 3 mm.

The insert may comprise a facing surface against which a portion of the component is formed. A portion of the parting line between the insert and holding piece may have a draft angle in the range of between 10 and 60 degrees with respect to the facing surface of the insert. Preferably, the draft angle is substantially 45 degrees. Having a parting line with a draft angle of 45 degrees allows the insert to be separated from the holding piece more readily.

The holding piece may include a facing surface against which a portion of the component is formed in use.

The component material may be one of a group of materials consisting of titanium alloys. The titanium alloys may include aluminium and vanadium.

HIPing of titanium alloys requires a thermal soak in the order of 900 degrees centigrade with pressures in the order of 100 MPa to 140 MPa. Hence, it is necessary to use a mould material which can withstand this temperature and pressure without deforming or compressing. Hence, the first part may be made from a substantially incompressible material which does not deform during the HIP process so as to be re-usable. The first part material may be one of a group of materials consisting of high temperature capable nickel alloys.

The Nickel alloys may include chronite and turbine blade casting alloys.

A further advantage of the Nickel alloy should be that it does not bond to itself or a titanium component or a canister alloy during or after HIPing. Hence, the first and second parts of the mould assembly can be separated from the formed component without damage.

The insert may include a parting line which dissects the insert into pieces. There may be two or more insert pieces. The insert pieces may be symmetrical. The insert pieces may be similar in size and shape. The insert pieces parting line may be flat so as to not be interlocking. The insert pieces parting line may extend perpendicularly from the facing surface of the insert.

The formation which mateably receives the insert may be an aperture. The aperture may pass through the holding piece such that a force can be applied to the insert from the exterior of the mould assembly so as to remove the insert from the holding piece after use. This aids with the separation of the holding piece and insert.

The recess may include a through-hole such that the powder in-fill can be exposed to an external side of the insert. Having a through-hole in the insert allows the powder in-fill to contact the canister so as to be compacted during the HIP process. If the powder in-fill for a protrusion is entirely within an insert then there may be insufficient pressure to on the distal portion of the protrusion during the HIP process to enable full consolidation.

The insert may include a recess having walls which extend at substantially 90 degrees from the facing surface of the insert. Alternatively, the walls may extend from the facing surface at an angle less than 90 degrees. The cross sectional area of the recess may increase along the length of a recess such that a formed protrusion can have an overhang with respect to the facing surface.

In a second aspect, the present invention provides A method of forming a component using hot isostatic pressing, the method using a mould assembly which comprises an insert having a plurality of pieces which combine to provide a recess in which a protrusion of the component can be formed; and, a holding piece having at least one cavity in which the insert is mateably received, the method including the steps of:

mateably inserting the insert pieces into the holding piece cavity to provide an assembled mould; placing the assembled mould into a canister; filling the canister with a powder in-fill which will form the component;

evacuating the canister; applying a thermal and pressure cycle to the canister to consolidate the powdered constituent material;

removing the canister from the component and mould; removing the holding piece from the component and insert pieces; and, individually removing the insert pieces.

Where the cavity which mateably receives the insert is an aperture which passes through the holding piece such that a force can be applied to the insert from the exterior of the mould assembly so as to remove the insert from the holding piece after use, the method of the second aspect may further comprise the step of: applying a force to the insert from the second surface of the holding piece so as to separate the holding piece and insert.

Embodiments of the invention will now be described with the aid of following Figures in which:

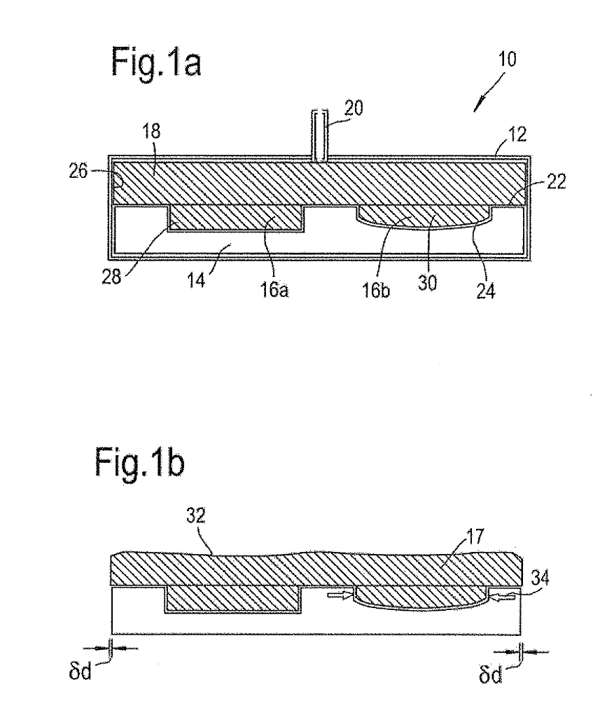

FIGS. 1a and 1b show a mould assembly in cross-section before and after a HIP process, respectively.

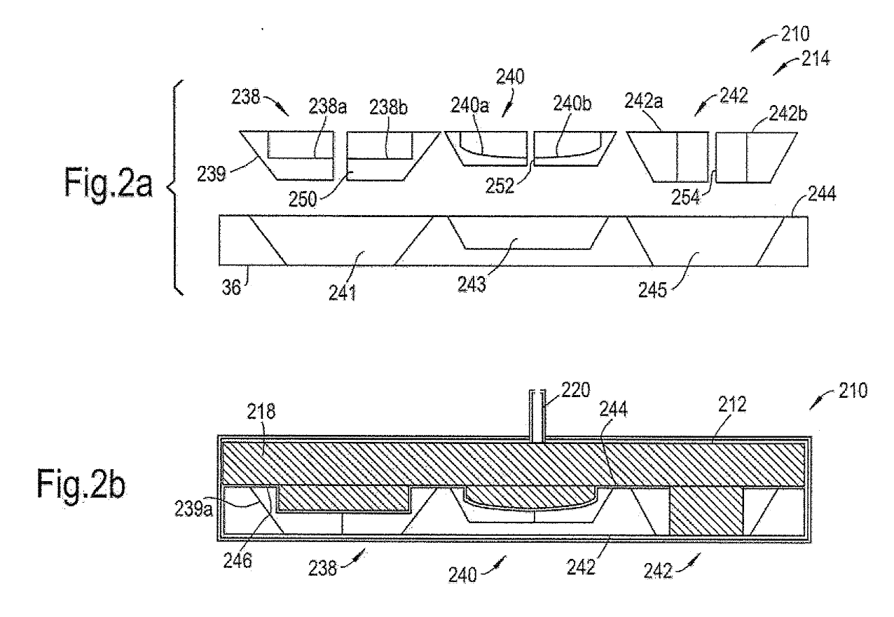

FIGS. 2a and 2b show a multiple piece HIP mould in cross section according to the present invention.

FIG. 1a shows a HIP mould assembly 10 comprising a canister 12 in the form of a mild steel box, a reusable mould 14 having a plurality of recesses 16a, 16b and a powder in-fill 18, which forms a component 17 once consolidated during the HIPing process. The powder in-fill 18 is introduced to the canister 12 via a filling tube 20 and fills the void defined between the upper 22 and recess 24 surfaces of the reusable mould 14 and the walls 26 of the canister 12.

The powder in-fill 18 is consolidated during a HIP process so as to form a component 17 and includes the constituent materials which make up the component. In the present embodiment the formed component 17 is a titanium alloy which is a particularly useful material for gas turbine engine components due to the low density and low high temperature creep. The titanium alloy is Ti6/4. Suitable particle sizes for HIPing with titanium alloys typically range from 50 to 300 microns. Of course the skilled person will appreciate that other materials can readily be used in HIP manufacturing as is known in the art.

The mould 14 is a substantially incompressible block of nickel alloy having a surface which has been machined to provide the component shape which is desired. The surface includes a facing surface 22 and cavities 16a 16b which correspond to protruding features 28 30 in the form of bosses. The protrusions 28 30 extend perpendicularly from the face of the component and include respective planar and curved distal faces. The recess surfaces 24 and upper surface 22 of the mould 14 together provide the contour of the consolidated component 17. The skilled man will appreciate that the geometry of the mould needs to be calculated to allow for the thermal expansion of the mould at the HIP temperature and the contraction of the cooled component 17.

The canister 12 is a mild steel vessel in which the mould 14 can be placed prior to being sealed shut, typically by having a lid welded in place. The canister 12 needs to be of a suitable thickness so as to maintain the sealed environment for the mould 14 and powder in-fill 18 during the HIP process. This thickness will vary according to the material and dimensions of the component 17 being produced but is typically in the order of a few millimetres.

To form a component from titanium alloys it is necessary to use a high temperature soak, typically in the range of 900 degrees. Hence, the reusable mould 14 needs to be of a suitable material to withstand the necessary high temperature. Nickel alloys are generally suitable for making reusable moulds 14 for HIP. Further, some nickel alloys tend not to bond to titanium alloy components which helps with the separation of the mould 14 and component after the HIP is complete.

To form a component 17, the mould 24 is loaded into the canister 12 which is then sealed. The powder in-fill 18 is injected into the canister 12 via tube 20 so as to fill the void which is defined by the walls 26 of the canister 12 and the facing surface of the mould 14. Any air which remains in the canister 12 is evacuated from the void using a vacuum pump. A typical evacuation pressure is 1.3 Pa. The canister 12 is placed within a pressure vessel which is also evacuated before being filled with and inert gas such as Argon. The canister is then subjected to a temperature soak of approximately 900 degrees under an external pressure of approximately 120 MPa to 140 MPa for between 2 and 4 hours before being cooled and removed from the pressure vessel.

Once cooled, the canister 12 is removed via a combination of machining and pickling before the component 17 is taken from the mould and machined to provide the finished article.

During the HIP process, the temperature soak and pressure consolidate the powder in-fill 18 so as to form a homogenous component 17. FIG. 1b shows the component 17 and mould 14 after the HIP process, with the canister 12 removed for clarity. The upper surface 32 of the component 17 as viewed in FIG. 1b is deformed as a result of the isostatic pressure and compaction which occurs during the HIP process. This deformation is typically removed in a subsequent machining step to provide the finished component.

The powder in-fill 18 and mould 14 expand during the thermal soak and contract during the subsequent cooling. As the mould 14 and in-fill 18 material are made respectively from a nickel alloy and a titanium alloy they have different coefficients of thermal expansion. Specifically, the nickel alloy of the mould 14 has a higher coefficient of thermal expansion and therefore contracts to a greater degree than the component 17 during the cooling phase. Hence, after cooling the component protrusions 28, 30, are larger than the mould 14 by an amount two times delta d, as shown in FIG. 1b.

Because the protrusions 28 30 are entirely surrounded by the recesses 16a, 16b, a compressive force which acts to grip and retain the protrusions 28, 30 within the respective recesses 16a, 16b results (as shown in FIG. 1b by arrows 34). This retention prevents the mould being readily separated from the component so a large force is required which can result in damage to the mould 14 and or component 17.

The present invention provides a mould assembly 210 as shown in FIGS. 2a and 2b. The mould assembly 210 generally includes a holding piece 236 and inserts 238, 240, 242, which form the recesses in the mould assembly 210. The inserts 238, 240, 242, include a plurality of insert pieces 238a,b, 240a,b, 242a,b, which are retained in corresponding cavities in the holding piece 236 and which combine to form the recess required for a component protrusion.

All of the inserts 238, 240, 242 are generally a truncated cone shape with the larger end of the cone providing the facing surface 246 for abutting the powder in-fill 218 and the narrow end seated within the holding piece 236. When the inserts 238, 240, 242 are located in the holding piece 236, the facing surfaces 246 of the inserts and the facing surface 244 of the holding piece 236 are flush so as to provide a continuous smooth profile against which the component can be formed.

The first insert 238 on the left of the mould assembly 210 as viewed in FIGS. 2a and 2b, has a recess 239 within the conical body in the form of a cylinder having a circumferential side wall and flat circular base surface. The open end of the recess is defined as the first end and the base of the recess is defined as the second end. The insert is mateably received within a cavity 241 in the holding piece in the form of an aperture which passes from the facing surface 244 of the holding piece 236 to a second surface 248 on the exterior of the holding piece 236. The holding piece 236 and insert 238 mate so as to define a parting line 239a along the angled conical face 239 of the insert 238. The parting line 239a of the embodiment is at 45 degrees relative to the facing surface 246 of the insert 238. Having a parting line 239a of 45 degrees between the holding piece 236 and insert 238 allows the two parts to be easily separated after the HIP process is complete.

When the insert 238 is mateably received within the aperture 241 in the holding piece 236, as shown in FIG. 2b, the rear of the insert 238 is exposed from the exterior surface 248 of the holding piece 236. This allows pressure to be applied directly to the rear surface of the insert 238 from the exterior of the mould assembly 210 once the canister has been removed, which aids separation of the holding piece 236 and insert 238.

The second insert 240 is similar to the first insert 238 but is mateably received within a closed cavity 243 and has a curved circular base so as to provide the corresponding component protrusion with a domed distal end. The closed cavity 243 forms a parting line with the insert which is parallel to the facing surface 246 of the insert 240. Hence, when the second insert 240 is placed within the closed cavity 243 the holding piece 236 envelopes the rear of insert 240.

The third insert 242 includes a through-hole rather than a closed recess. The through-hole allows the powder in-fill 218 to be exposed from a rear side of the insert 242 such that when it is inserted into the canister 212, pressure is more effectively applied to the second end of the recess which is in direct contact with the canister 212. The third insert 242 is situated within a cavity in the form of an aperture 245 in a similar way to the first insert 238.

Each of the inserts 238, 240, 242 include two insert pieces which are symmetrical about a central parting line 250, 252, 254, which dissects each insert 238, 240, 242. The parting lines 250, 252, 254, between pieces are flat and extend perpendicularly from the facing surface 246 of each insert so as to provide no interlock therebetween. In this way, the inserts 238, 240, 242, are held together at the parting lines 250, 252, 254, by the holding piece 236 and powder in-fill 218 only.

Having multiple pieces within a given insert 238, 240, 242, allows the insert to be disassembled from the component protrusion after a component has been formed during the HIP process. Specifically, the arrangement of the insert pieces 238, 240, 242, is such that each piece can be removed from the facing surface of the component at an oblique (or perpendicular) angle rather than parallel to and against any frictional retaining force. Hence, the frictional retaining force which results from the differential thermal contraction between the component and the first part 214 of the mould can be negated.

The inserts 238, 240, 242, and holding piece 236 are made from the same material, Nickel alloy, so as to provide the first part 214 with a uniform thermal expansion and contraction.

To form a component, the first part 214 is loaded into the canister 212 which is then sealed. The powder in-fill 218 is injected into the canister 212 via tube 220 so as to fill the void which is defined by the walls 226 of the canister 212 and the facing surface of the first part 214. Any air which remains in the canister 212 is evacuated from the void using a vacuum pump. A typical evacuation pressure is 1.3 Pa. The canister 612 is placed within a pressure vessel which is also evacuated before being filled with and inert gas such as Argon. The canister is then subjected to a temperature soak of approximately 900 degrees under an external pressure of approximately 120 MPa to 140 MPa for between 2 and 4 hours before being cooled and removed from the pressure vessel. Once the HIP process is complete the canister 612 can be removed by machining and pickling.

After the canister 212 is removed, the holding piece 236 can be removed from the component and inserts 238, 240, 242, simply by applying a pulling force to the holding piece 236. Once the holding piece 236 is removed, the inserts 238, 240, 242 are free to separate into the individual insert pieces which are individually removed from the formed protrusions.

The skilled person will appreciate that the above described embodiments are demonstrative, not restrictive, and that the scope of the invention is determined by the claims. For example, the invention is primarily described in the context of a re-usable mould. However, the invention could be implemented on a disposable mould.

Further, the component and mould materials are not restricted to Titanium alloys and Nickel alloys respectively. Although the present invention is described in the context of large components for gas turbine engines, it will be understood that the invention is a generic one which may find application elsewhere.

1. A mould assembly for a hot isostatic pressing, HIP, process, comprising:
an insert comprising a plurality of pieces which combine to provide a recess in which a protrusion of the component can be formed; and, a holding piece having at least one cavity in which the insert is mateably received.

2. A mould assembly as claimed in claim 1 wherein the holding piece includes a facing surface against which a portion of the component is formed in use.

3. A mould assembly as claimed in claim 2 wherein the insert comprises a facing surface against which a portion of the component is formed, and wherein a portion of the parting line between the insert and holding piece has a draft angle with respect to the facing surface of the insert is in the range of between 10 and 60 degrees.

4. A mould assembly as claimed in claim 1 wherein the mould material is suitable for forming a component from a titanium alloy.

5. A mould assembly as claimed in claim 1 wherein in the holding piece and insert are made from a nickel alloy.

6. A mould assembly as claimed in claim 1 wherein the cavity which mateably receives the insert is an aperture which passes through the holding piece such that a force can be applied to the insert from the exterior of the mould assembly so as to remove the insert from the holding piece after use.

7. A mould assembly as claimed in claim 1 wherein the recess includes a through-hole.

8. A method of forming a component using hot isostatic pressing, the method using a mould assembly which comprises an insert having a plurality of pieces which combine to provide a recess in which a protrusion of the component can be formed; and, a holding piece having at least one cavity in which the insert is mateably received, the method including the steps of:
mateably inserting the insert pieces into the holding piece cavity to provide an assembled mould;
placing the assembled mould into a canister;
filling the canister with a powder in-fill which will form the component;
evacuating the canister;
applying a thermal and pressure cycle to the canister to consolidate the powdered constituent material;
removing the canister from the component and mould;
removing the holding piece from the component and insert pieces; and,
individually removing the insert pieces.

9. A method as claimed in claim 8 wherein the cavity which mateably receives the insert is an aperture which passes through the holding piece such that a force can be applied to the insert from the exterior of the mould assembly so as to remove the insert from the holding piece after use, the method comprising the further step of: applying a force to the insert from the second surface of the holding piece so as to separate the holding piece and insert.
